(19) United States
(12) Patent Application Publication
(10) Pub. No.: US 2012/0320127 A1
(43) Pub. Date: Dec. 20, 2012

(54) IMAGE FORMING APPARATUS

(75) Inventors: Makoto Kikura, Kanagawa (JP); Tsuguyori Kemma, Kanagawa (JP); Norikazu Yanase, Kanagawa (JP)

(73) Assignee: RICOH COMPANY, LTD., Tokyo (JP)

(21) Appl. No.: 13/478,197

(22) Filed: May 23, 2012

(30) Foreign Application Priority Data
Jun. 14, 2011 (JP) 2011-132100

(51) Int. Cl. B41J 23/00

(52) U.S. Cl. 347/37

(57) ABSTRACT

An image forming apparatus including a carriage, an image forming unit installed in the carriage to eject liquid onto a recording medium, a guide member to guide the carriage in a main scanning direction corresponding to a width direction of the recording medium, and a position restriction member detachably attachable to the carriage to restrict a position of the carriage relative to the guide member in a vertical direction. The carriage includes a first slide member slidably supported by the guide member, a second slide member that slidably contacts the guide member to prevent rotation of the carriage relative to the guide member, and a third slide member that slidably contacts the guide member to determine a position of the carriage in a sub-scanning direction perpendicular to the main scanning direction. The position of the carriage is not restricted by the guide member in the vertical direction.

### CROSS-REFERENCE TO RELATED APPLICATION

The present patent application is based on and claims priority pursuant to 35 U.S.C. §119 from Japanese Patent Application No. 2011-132100, filed on Jun. 14, 2011 in the Japan Patent Office, which is incorporated by reference herein in its entirety.

### BACKGROUND OF THE INVENTION

1. Field of the Invention

Exemplary aspects of the present invention generally relate to an inkjet-type image forming apparatus in which a recording head that ejects liquid droplets onto a recording medium is installed in a carriage to form an image on the recording medium.

2. Description of the Related Art

An inkjet-type image forming apparatus typically includes a mechanism that moves a carriage mounting a recording head reciprocally back and forth laterally across a recording medium along a guide member. Upon replacement of the carriage due to breakdown of the recording head or the like, the carriage is withdrawn from the guide member in the width direction of the recording medium. Because many other components also need to be detached from the image forming apparatus in order to withdraw the carriage from the guide member, it takes a lot of time and work to replace the carriage. In addition, sufficient horizontal space is needed in the image forming apparatus for installation and detachment of the carriage in and from the image forming apparatus.

In fact, few attempts have been made to facilitate installation and detachment of the carriage in and from the image forming apparatus because the recording head is often configured to be detachably installable in the carriage and because replacement of the carriage is not often needed. Consequently, many other components still need to be detached from the image forming apparatus upon replacement of the carriage before the carriage itself is removed, thus complicating removal. Finally, it is difficult to spare sufficient installation space for the carriage within the increasingly compact image forming apparatus, thereby further hindering replacement of the carriage.

### BRIEF SUMMARY OF THE INVENTION

In view of the foregoing, illustrative embodiments of the present invention provide a novel image forming apparatus in which a carriage can be easily attached to and detached from a guide member in the image forming apparatus without an increase in installation space for the carriage within an image forming apparatus.

In one illustrative embodiment, an image forming apparatus includes a carriage, an image forming unit installed in the carriage to eject liquid onto a recording medium to form an image on the recording medium, a guide member to guide the carriage in a main scanning direction corresponding to a width direction of the recording medium, and a position restriction member detachably attachable to the carriage to restrict a position of the carriage relative to the guide member in a vertical direction. The carriage includes a first slide member slidably supported by the guide member, a second slide member that slidably contacts the guide member to prevent rotation of the carriage relative to the guide member, and a third slide member that slidably contacts the guide member to determine a position of the carriage in a sub-scanning direction perpendicular to the main scanning direction. The position of the carriage is not restricted by the guide member in the vertical direction.

Additional features and advantages of the present disclosure will become more fully apparent from the following detailed description of illustrative embodiments, the accompanying drawings, and the associated claims.

### BRIEF DESCRIPTION OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a perspective view illustrating the external appearance of an example of an image forming apparatus according to illustrative embodiments;

FIG. 2 is a schematic plan view illustrating an example of a configuration of a mechanical portion of the image forming apparatus illustrated in FIG. 1;

FIG. 3 is a partial perspective view illustrating the configuration of the mechanical portion illustrated in FIG. 2;

FIG. 4 is a vertical cross-sectional view illustrating an example of a configuration of a carriage included in an image forming apparatus according to a first illustrative embodiment;

FIG. 5 is a perspective view illustrating the configuration of the carriage viewed from the front;

FIG. 6 is a schematic view illustrating the configuration of the carriage viewed from the front;

FIG. 7 is a vertical cross-sectional view illustrating an example of a configuration of a carriage according to a first comparative example;

FIG. 8 is a vertical cross-sectional view illustrating an example of a configuration of a carriage according to a second comparative example;

FIG. 9 is a vertical cross-sectional view illustrating an example of a configuration of a carriage according to a third comparative example;

FIG. 10 is an enlarged partial vertical cross-sectional view illustrating the configuration of the carriage according to the first illustrative embodiment;

FIG. 11(a) is a side view illustrating an example of a configuration of a cover attached to the carriage;

FIG. 11(b) is a plan view illustrating the configuration of the cover illustrated in FIG. 11(a);

FIG. 12 is a vertical cross-sectional view illustrating a state in which the cover is attached to the carriage inserted into a guide member according to the first illustrative embodiment;

FIG. 13 is a vertical cross-sectional view illustrating a state in which a cover is attached to a carriage inserted into a guide member according to a second illustrative embodiment;

FIG. 14 is a perspective view illustrating an example of a configuration of the guide member and the carriage to which the cover is not attached according to the second illustrative embodiment;

FIG. 15 is a perspective view illustrating an example of a configuration of the guide member and the carriage to which the cover is attached according to the second illustrative embodiment; and

FIG. 16 is a vertical cross-sectional view illustrating an example of a configuration of an interior of the carriage inserted into the guide member when the cover is attached to the carriage.

### DETAILED DESCRIPTION OF ILLUSTRATIVE EMBODIMENTS

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Illustrative embodiments of the present invention are now described below with reference to the accompanying drawings.

In a later-described comparative example, illustrative embodiment, and exemplary variation, for the sake of simplicity the same reference numerals will be given to identical constituent elements such as parts and materials having the same functions, and redundant descriptions thereof omitted unless otherwise required.

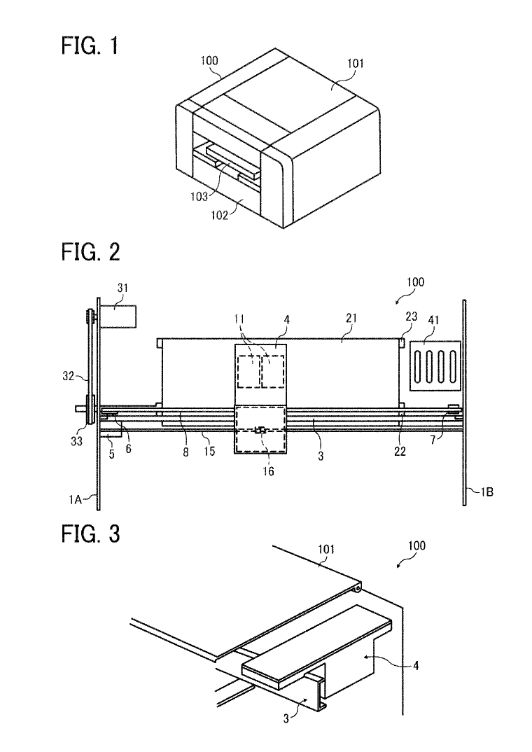

A configuration and operation of an image forming apparatus 100 according to illustrative embodiments are described below, with reference to FIGS. 1 and 2. FIG. 1 is a perspective view illustrating the external appearance of the image forming apparatus 100 according to illustrative embodiments. FIG. 2 is a schematic plan view illustrating an example of a configuration of a mechanical portion of the image forming apparatus 100.

The image forming apparatus 100 is a serial-type inkjet recording device. A cover 101 closably openable relative to the body of the image forming apparatus 100 is provided on an upper surface of the image forming apparatus 100. A user opens the cover 101 to access the mechanical portion of the image forming apparatus 100.

In the mechanical portion, a carriage 4 is slidably supported by a guide member 3 extended between left and right main lateral plates 1A and 1B in a main scanning direction. The carriage 4 is reciprocally movable back and forth in the main scanning direction by a main scanning motor 5 via a timing belt 8 wound around a drive pulley 6 and a driven pulley 7.

An image forming unit, which, in the present illustrative embodiment, includes two recording heads 11 each constituted of a liquid droplet ejection head that ejects liquid droplets of a specific color, that is, yellow (Y), cyan (C), magenta (M), or black (K), and a head tank that supplies ink to the liquid droplet ejection head, is installed in the carriage 4. Nozzle arrays each constituted of multiple nozzles are provided to a nozzle face of each of the recording heads 11 and arrayed in a sub-scanning direction perpendicular to the main scanning direction, such that the recording heads 11 eject liquid droplets of the specified colors vertically downward.

An encoder scale 15 is disposed along the main scanning direction of the carriage 4, and an encoder sensor 16 (in the present embodiment, a transmissive photosensor) that reads a positional identifier, that is, a scale in the encoder scale 15, is mounted on the carriage 4.

A conveyance belt 21 that conveys a recording medium in the sub-scanning direction is disposed below the carriage 4. The conveyance belt 21 is constructed of an endless belt wound around a conveyance roller 22 and a tension roller 23. The conveyance roller 22 is rotatively driven by a sub-scanning motor 31 via a timing belt 32 and a timing pulley 33 to rotate the conveyance belt 21 in the sub-scanning direction, that is, a direction of conveyance of the recording medium.

A servicing mechanism 41 that services the recording heads 11 is provided on one side of the mechanical portion next to the conveyance belt 21 in the main scanning direction of the carriage 4. The servicing mechanism 41 includes a cap member that covers the nozzle face of each of the recording heads 11, a wiper that wipes off the nozzle face, and a receiver to which liquid droplets not used for image formation are idly ejected.

The image forming apparatus 100 further includes a sheet feed tray 102 that holds recording media to be fed sequentially to the conveyance belt 21, and a discharge tray 103 to which a recording medium having an image formed thereon by the recording heads 11 is discharged. The sheet feed tray 102 is detachably attachable to the image forming apparatus 100.

In the image forming apparatus 100, the recording medium fed from the sheet feed tray 102 is intermittently conveyed by the conveyance belt 21. The recording heads 11 are driven based on image signals while the carriage 4 is moved in the main scanning direction so that liquid droplets are ejected from the recording heads 11 onto the recording medium, which remains stationary, so as to form a predetermined number of lines of an image to be formed on the recording medium. Thereafter, the conveyance belt 21 conveys the recording medium by a predetermined amount to perform image formation of the next lines. The above-described processes are repeated to form the image on the recording medium. Upon completion of image formation, the recording medium having the image thereon is discharged to the discharge tray 103.

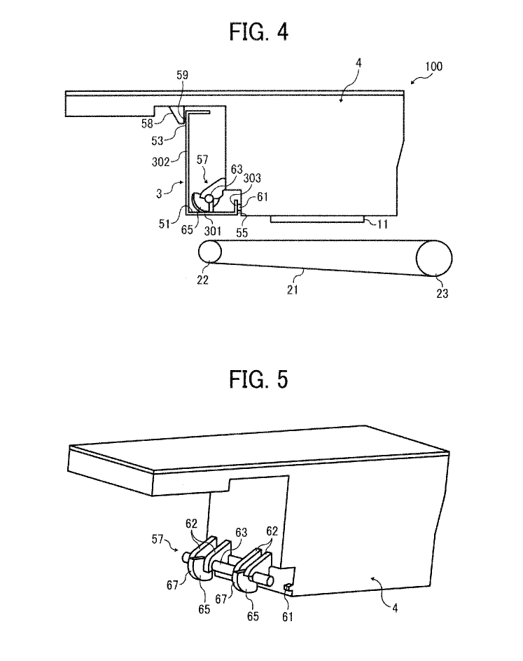

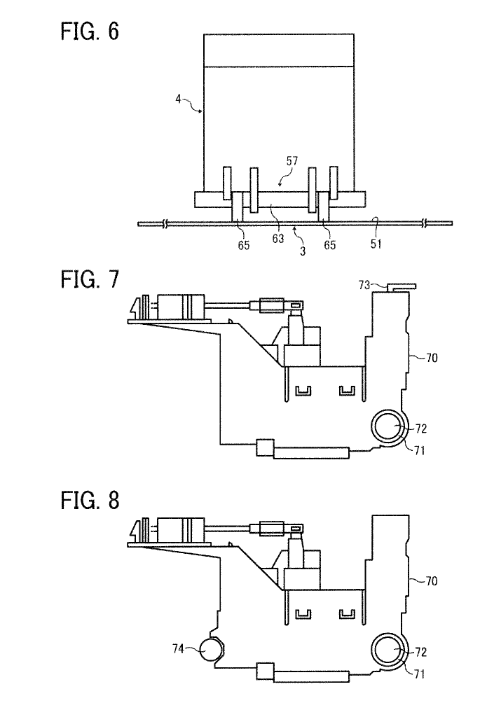

A description is now given of a configuration that supports the carriage 4 in the image forming apparatus 100 according to a first illustrative embodiment, with reference to FIGS. 3 to 6. FIG. 3 is a partial perspective view illustrating the configuration of the mechanical portion illustrated in FIG. 2. FIG. 4 is a vertical cross-sectional view illustrating an example of a configuration of the carriage 4 according to the first illustrative embodiment. FIG. 5 is a perspective view illustrating the configuration of the carriage 4 viewed from the front. FIG. 6 is a schematic view illustrating the configuration of the carriage 4 viewed from the front.

The guide member 3 is formed of a metal plate and has first, second, and third portions 301, 302, and 303. An inner surface of the first portion 301 serves as a first guide surface 51, an outer surface of the second portion 302 serves as a second guide surface 53, and an outer surface of the third portion 303 serves as a third guide surface 55. Each of the first, second, and third guide surfaces 51, 53, and 55 supports and slidably guides the carriage 4. The carriage 4 has a first slide member 57 slidably supported by the first guide surface 51, a second slide member 59 that slidably contacts the second guide surface 53, and a third slide member 61 that slidably contacts the third guide surface 55. The first guide surface 51 of the guide member 3 determines the position of the carriage 4 in a vertical direction. The second guide surface 53 receives torque from the carriage 4 caused by the weight of the carriage 4 itself to prevent rotation of the carriage 4 relative to the guide member 3. The third guide surface 55 determines the position of the carriage 4 in the sub-scanning direction.

Returning to FIG. 2, the encoder scale 15 is provided in front of the guide member 3 in the image forming apparatus 100. The carriage 4 further includes an encoder scale guide member 58 that guides the encoder scale 15. The encoder scale guide member 58 protrudes downward from an upper portion of the carriage 4. The second slide member 59 that prevents rotation of the carriage 4 extends from the encoder scale guide member 58 toward the guide member 3 to slidably contact the guide member 3. Therefore, the encoder scale guide member 58 has both functions of guiding the encoder scale 15 and preventing rotation of the carriage 4.

As illustrated in FIGS. 5 and 6, the first slide member 57 of the carriage 4 has a shaft 63 extending in the main scanning direction. The shaft 63 is rotatably held by four holding members 62 each fixed to the carriage 4. Two cam members 65 each having a slide surface 67 that slidably contacts the first guide surface 51 are provided to the shaft 63.

In order to facilitate an understanding of the present invention, reference is now made to several comparative examples illustrating common problems in detaching the carriage from the image forming apparatus using conventional configurations.

FIG. 7 is a vertical cross-sectional view illustrating an example of a configuration of a carriage 70 according to a first comparative example.

The carriage 70 is supported and guided by a guide rod 72 passing through a bearing 71 to move reciprocally back and forth in the main scanning direction perpendicular to the plane of FIG. 7. A guide rail 73 is provided to an upper portion of the carriage 70 to support the carriage 70, thereby preventing the carriage 70 from rotating around the guide rod 72 by the weight of the carriage 70 itself.

FIG. 8 is a vertical cross-sectional view illustrating an example of a configuration of a carriage 70 according to a second comparative example.

In the second comparative example, a rear portion of the carriage 70 is supported and guided by a guide rod 72 passing through a bearing 71 to move reciprocally back and forth in the main scanning direction perpendicular to the plane of FIG. 8. In addition, a sub-guide rod 74 is provided to a front portion of the carriage 70 to support the carriage 70, thereby preventing the carriage 70 from rotating around the guide rod 72 by the weight of the carriage 70 itself

Because the guide rod 72 passes through the carriage 70 in both of the configurations illustrated in FIGS. 7 and 8, respectively, the carriage 70 needs to be withdrawn from the guide rod 72 in the main scanning direction upon detachment of the carriage 70 from the guide rod 72. Consequently, withdrawal of the carriage 70 from the guide rod 72 requires detachment of many other components, resulting in a greater burden on the user.

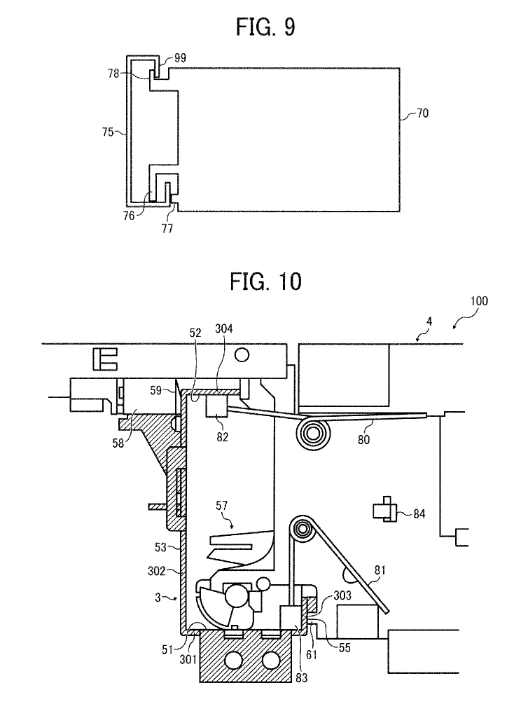

FIG. 9 is a vertical cross-sectional view illustrating an example of a configuration of a carriage 70 according to a third comparative example.

In the third comparative example, a rear portion of the carriage 70 is supported only by a sheet-metal guide rail 75. The carriage 70 is positioned at three portions 76, 77, and 78 by respective guide surfaces of the guide rail 75 to move reciprocally back and forth in the main scanning direction perpendicular to the plane of FIG. 9. Specifically, the position of the carriage 70 is restricted in the vertical direction by the portion 76 and in the sub-scanning direction by the portion 77. Further, the portion 78 prevents rotation of the carriage 70 relative to the guide rail 75. In addition, a biasing member such as a spring, not shown, is often provided to prevent looseness between the carriage 70 and the guide rail 75 caused by a gap between the guide rail 75 and each of the portions 76, 77, and 78.

In the configuration illustrated in FIG. 9, a hook-shaped portion 99 that contacts the portion 78 of the carriage 70 extends downward from an upper portion of the guide rail 75 to prevent rotation of the carriage 70. Because the hook-shaped portion 99 also prevents slippage of the carriage 70 in the vertical direction, the carriage 70 needs to be withdrawn from the guide rail 75 in the main scanning direction upon detachment of the carriage 70 from the guide rail 75. Consequently, withdrawal of the carriage 70 from the guide rail 75 requires detachment of many other components, again burdening the user.

FIG. 10 is an enlarged partial vertical cross-sectional view illustrating the configuration of the carriage 4 attached to the guide member 3 according to the first illustrative embodiment. Looseness between the carriage 4 and the guide member 3 is prevented by a biasing force from each of two biasing members, which, in the present illustrative embodiment, are torsion coil springs 80 and 81.

The guide member 3 has a substantially U-shaped cross-section, without a portion that restricts the position of the carriage 4 in the vertical direction. Specifically, the guide member 3 further has a fourth portion (upper portion) 304 provided to an upper part of the guide member 3. The fourth portion 304 extends in a horizontal direction from the second portion (vertical portion) 302 that has the second guide surface (vertical guide surface) 53 and extends in the vertical direction, and an inner surface of the fourth portion 304 serves as a fourth guide surface (upper guide surface) 52. The first guide surface 51 provided to the first portion 301 in a lower part of the guide member 3 extends beyond the fourth guide surface 52 in the horizontal direction from the second portion 302. The third portion 303 having the third guide surface 55 extends upward from the first portion 301. The carriage 4 is attached to the guide member 3 from the right to the left in FIG. 10.

The two torsion coil springs 80 and 81 each fitted onto respective protrusions, are provided to each of lateral surfaces of the carriage 4. A slide portion 82 extending along the guide member 3 in the main scanning direction perpendicular to the plane of FIG. 10 is provided to a leading edge of one of arms of the torsion coil spring 80 provided above the torsion coil spring 81. The slide portion 82 is formed of, for example, light and strong plastic, and has a length substantially equal to a length of the carriage 4 in the main scanning direction to contact the fourth guide surface 52 of the guide member 3.

The other arm of the torsion coil spring 80 is engageable with a hook 84 to provide a biasing force to the torsion coil spring 80. It is to be noted that in the state shown in FIG. 10, the other arm of the torsion coil spring 80 does not engage the hook 84 so that no biasing force is provided to the torsion coil spring 80. When the other arm of the torsion coil spring 80 does engage the hook 84, the biasing force is generated in the torsion coil spring 80 so that the slide portion 82 contacting the fourth guide surface 52 supplies an upward force to the guide member 3. As a result, looseness between the carriage 4 and the guide member 3 and rotation of the carriage 4 relative to the guide member 3 can be prevented.

In addition, a slide portion 83 extending along the guide member 3 in the main scanning direction is provided to a leading edge of one of arms of the torsion coil spring 81 provided below the torsion coil spring 80. The slide portion 83 is formed of, for example, light and strong plastic, and has a length substantially equal to the length of the carriage 4 in the main scanning direction to contact an inner surface of the third portion 303 of the guide member 3 opposite the third guide surface 55.

The other arm of the torsion coil spring 81 is engageable with the hook 84 to provide a biasing force to the torsion coil spring 81. It is to be noted that in the state shown in FIG. 10, the other arm of the torsion coil spring 81 does not engage the hook 84 so that no biasing force is provided to the torsion coil spring 81. When the other arm of the torsion coil spring 81 does engage the hook 84, the biasing force is generated in the torsion coil spring 81 so that the slide portion 83 contacting the inner surface of the third portion 303 opposite the third guide surface 55 supplies a rightward force in FIG. 10 to the guide member 3. At the same time, the third slide member 61 of the carriage 4 supplies a leftward force in FIG. 10 to the guide member 3 via the third guide surface 55. Accordingly, the third portion 303 of the guide member 3 is sandwiched between the slide portion 83 and the third slide member 61. Thus, looseness between the carriage 4 and the guide member 3, in particular, rotation of the carriage 4 relative to the guide member 3, can be prevented.

Upon detachment of the carriage 4 from the guide member 3, first, the arm of each of the torsion coil springs 80 and 81 is simply disengaged from the hook 84, respectively, to release the biasing force from each of the torsion coil springs 80 and 81.

As described above, neither the guide member 3 nor the carriage 4 has a portion that restricts the position of the carriage 4 in the vertical direction. Specifically, the fourth guide surface 52 provided to the fourth portion 304 of the guide member 3 extends only in the horizontal direction from the second portion 302 extending in the vertical direction, and does not further extends downward. Accordingly, in the state illustrated in FIG. 10 in which the biasing force is released from each of the torsion coil springs 80 and 81, the carriage 4 can be easily detached upward from the guide member 3. Therefore, the carriage 4 does not need to be withdrawn from the guide member 3 in the main scanning direction. In addition, detachment of the carriage 4 from the guide member 3 does not require detachment of many other components, thereby achieving easy and fast detachment of the carriage 4 from the guide member 3.

While the carriage 4 slides against the guide member 3 during image formation, the slide portions 82 and 83 also slide against the guide member 3 as the carriage 4 is moved. At this time, the biasing force from each of the torsion coil springs 80 and 81 that prevents looseness between the carriage 4 and the guide member 3 is not large enough to prevent the carriage 4 from moving along the guide member 3.

As described above, neither the guide member 3 nor the carriage 4 has a portion that restricts the position of the carriage 4 relative to the guide member 3 in the vertical direction. Therefore, in the state illustrated in FIG. 10, the carriage 4 is not prevented from slipping off from the guide member 3 in the vertical direction. Consequently, the carriage 4 may slip off from the guide member 3 in the vertical direction when, for example, lifted from the guide member 3 by the user. In order to prevent the above-described problem, a position restriction member that restricts the position of the carriage 4 relative to the guide member 3 in the vertical direction, which, in the present illustrative embodiment, is a cover 85, is attached to the carriage 4.

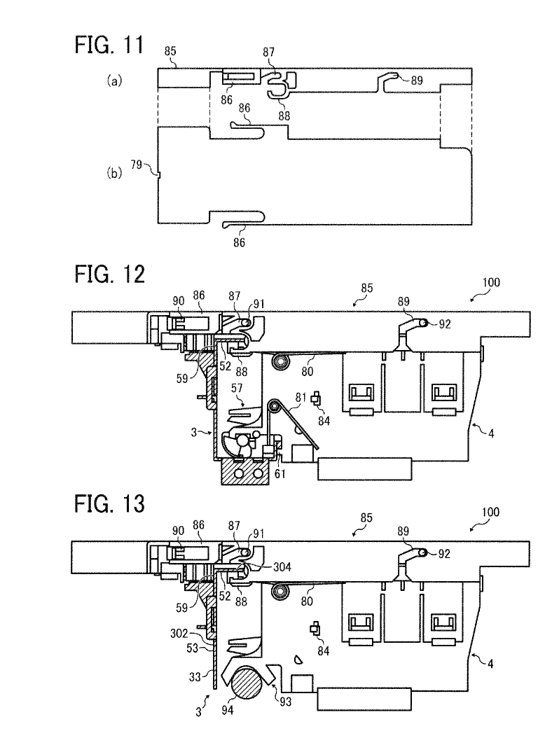

FIG. 11(a) is a side view illustrating an example of a configuration of the cover 85 attached to the carriage 4 viewed along arrow X in FIG. 15 described in detail later. FIG. 11(b) is a plan view illustrating the configuration of the cover 85 illustrated in FIG. 11(a).

The cover 85 is constructed of a flat upper surface and lateral surfaces extending downward from edges of the upper surface, respectively.

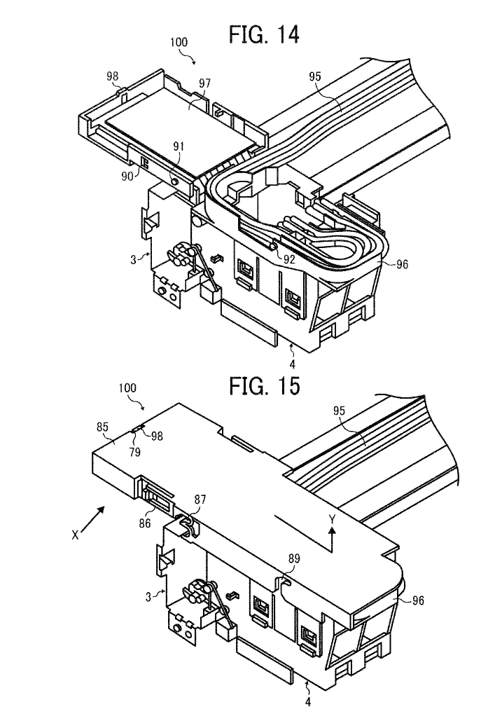

A reception portion 79 provided corresponding to a hook 98 formed in the upper portion of the carriage 4 as illustrated in FIG. 14 is formed on the upper surface of the cover 85. Each of the lateral surfaces of the cover 85 has an engagement portion 86 that snaps onto a protrusion 90 provided to the upper portion of each of the lateral surfaces of the carriage 4, groove-shaped receivers 87 and 89 that engage protrusions 91 and 92 provided to the upper portion of each of the lateral surfaces of the carriage 4, respectively, and a slippage prevention portion 88 that hooks onto the fourth guide surface 52 of the guide member 3 to prevent the carriage 4 from slipping off from the guide member 3 in the vertical direction.

The engagement portion 86 extends in a longitudinal direction of the cover 85 from each of the lateral surfaces of the cover 85, and has an opening at the center thereof The slippage prevention portion 88 extends in the longitudinal direction of the cover 85 from each of the lateral surfaces of the cover 85 and further extends upward so as to have a hook shape.

FIG. 12 is a vertical cross-sectional view illustrating a state in which the cover 85 is attached to the carriage 4 according to the first illustrative embodiment.

The cover 85 is placed on the upper surface of the carriage 4 and is inserted into the carriage 4 from right to left in FIG. 12 to be attached to the carriage 4. At this time, the protrusion 90 of the carriage 4 snaps onto the opening of the engagement portion 86 provided to the cover 85 so that the cover 85 is fixed to the carriage 4. Engagement of the protrusion 90 and the engagement portion 86 achieves easy attachment and detachment of the cover 85 to and from the carriage 4 without tools or the like, thereby providing user-friendly configuration.

In addition, the protrusions 91 and 92 of the carriage 4 engage the receivers 87 and 89 of the cover 85, respectively, so that fixation of the cover 85 to the carriage 4 is reinforced.

Upon detachment of the cover 85 from the carriage 4, the cover 85 is withdrawn to the right in FIG. 12 to disengage the protrusion 90 from the engagement portion 86 and then is lifted.

When the cover 85 is attached to the carriage 4, the hook-shaped slippage prevention portion 88 provided to the cover 85 enters below the fourth guide surface 52 of the guide member 3, thereby preventing the carriage 4 from slipping upward from the guide member 3. The cover 85 is attached only to the carriage 4 and does not contact the guide member 3. The above-described configuration makes the cover 85 more compact and the user can easily handle the cover 85, thereby facilitating attachment and detachment of the cover 85.

In addition, a gap is formed between the slippage prevention portion 88 of the cover 85 and the fourth guide surface 52 of the guide member 3. As a result, the carriage 4 can be smoothly moved on the guide member 3 without resistance from the guide member 3 via the cover 85.

A description is now given of a second illustrative embodiment of the present invention. FIG. 13 is a vertical cross-sectional view illustrating a state in which the cover 85 is attached to the carriage 4 according to the second illustrative embodiment.

In the second illustrative embodiment, the guide member 3 is constructed of a cylindrical first guide member, that is, a guide rod 94, and a second guide member 33 formed separately from the guide rod 94. The guide rod 94 slidably contacts a semi-circular slide member 93 provided to the carriage 4. The slide member 93 has an opening facing downward, and corresponds to the first and third slide members 57 and 61 of the carriage 4 according to the first illustrative embodiment. The second guide member 33 slidably contacts the second slide member 59 of the carriage 4. The guide rod 94 that guides and supports the slide member 93 is provided to the image forming apparatus 100 in the main scanning direction. The carriage 4 is attached to the second guide member 33 so that the slide member 93 is placed on the guide rod 94. As a result, the position of the carriage 4 is determined in both the vertical and sub-scanning directions, and the carriage 4 is slidable along the guide rod 94 in the main scanning direction.

The fourth portion 304 of the guide member 3 having the fourth guide surface 52 merely extends in the horizontal direction from the second portion 302 having the second guide surface 53, and does not have a hook shape. Therefore, when the cover 85 is attached to the carriage 4, the slippage prevention portion 88 hooks on the fourth guide surface 52 provided to the upper part of the guide member 3, thereby preventing the carriage 4 from slipping off upward from the guide member 3. By contrast, when the cover 85 is detached from the carriage 4 and the biasing force is released from the torsion coil spring 80, the carriage 4 can be easily detached upward from the guide member 3 without withdrawing the carriage 4 from the guide member 3 in the main scanning direction perpendicular to the plane of FIG. 13.

It is to be noted that the configuration of the cover 85 according to the second illustrative embodiment is the same as that of the first illustrative embodiment illustrated in FIGS. 11(a) and 11(b). Moreover, although the second guide member 33 is substantially L-shaped in cross-section and a lower part of the second guide member 33 does not extend horizontally from the second portion 302 having the second guide surface 53, the configuration of the guide member 33 is not limited thereto.

FIG. 14 is a perspective view illustrating a state in which the cover 85 is not attached to the carriage 4. FIG. 15 is a perspective view illustrating a state in which the cover 85 is attached to the carriage 4. It is to be noted that, although the carriage 4 and the guide member 3 according to the first illustrative embodiment are illustrated in FIGS. 14 and 15, a configuration described in detail below is also applicable to the second illustrative embodiment.

A printed circuit board assembly 97 that controls ejection of liquid droplets from the recording heads 11 is placed on the upper surface of the carriage 4. When the carriage 4 is attached to the guide member 3, a portion of the carriage 4 on which the printed circuit board assembly 97 is placed extends beyond the guide member 3. A tube guide member 96 within which ink tubes 95 connected to the head tanks installed in the recording heads 11 are accommodated is mounted on the upper portion of the carriage 4. In the state illustrated in FIG. 14, the ink tubes 95, the tube guide member 96, and the printed circuit board assembly 97 are not covered with the cover 85, and a position of each of the ink tubes 95 accommodated within the tube guide member 96 is not restricted in the vertical direction.

As described previously, the cover 85 is fixed to the carriage 4 by engagement of the engagement portion 86 with the protrusion 90, the receivers 87 and 89 with the protrusions 91 and 92, respectively, and the reception portion 79 with the hook 98. As illustrated in FIG. 15, the upper surface of the carriage 4 is covered with the cover 85 such that the ink tubes 95, the printed circuit board assembly 97, the recording heads 11, and so forth are accommodated within the carriage 4. Accordingly, entrance of foreign substances such as dust and ink mist into the carriage 4 can be prevented. The cover 85 is easily detached from the carriage 4 by sliding the cover 85 in a direction indicated by arrow Y in FIG. 15.

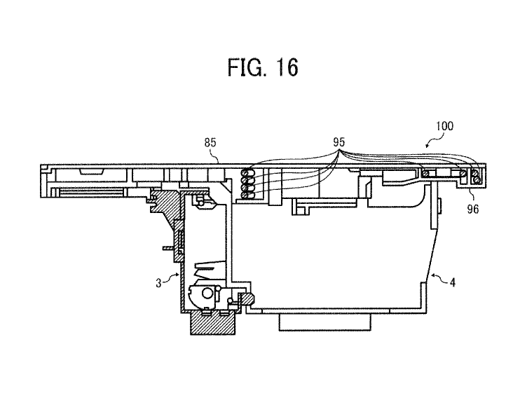

FIG. 16 is a vertical cross-sectional view illustrating an example of a configuration of the interior of the carriage 4 attached to the guide member 3 when the cover 85 is attached to the carriage 4.

As illustrated in FIG. 16, the ink tubes 95 disposed within the tube guide member 96 provided to the upper portion of the carriage 4 are pressed downward by the cover 85, thereby restricting vertical movement of the ink tubes 95. As a result, while the carriage 4 is moved reciprocally back and forth in the main scanning direction during image formation, vertical or horizontal movement of the ink tubes 95 within the carriage 4 can be prevented, thereby preventing damage to the ink tubes 95.

It is preferable that the cover 85 be formed of an elastic material such as elastomer. As a result, impact or scratches against the carriage 4 or the guide member 3 due to contact of the ink tubes 95 with the cover 85 or the slippage prevention portion 88 with the guide member 3 can be prevented even when the carriage 4 is lifted by the user without detaching the cover 85 from the carriage 4, thereby preventing damage to the components.

Alternatively, only the slippage prevention portion 88 that restricts the position of the carriage 4 in the vertical direction or a portion of the cover 85 that guides the ink tubes 95 need be formed of an elastic member such as elastomer. In such a case, the elastic material is used only for the required portion of the cover 85, thereby reducing the weight of the carriage 4 and thus reducing power consumption, and achieving energy-saving configuration.

As can be appreciated by those skilled in the art, the present invention is not limited to the foregoing illustrative embodiments. Thus, for example, the shape of the cover 85, and the shape, position, and number of each of the reception portion 79, the engagement portion 86, the receivers 87 and 89, and the slippage prevention portion 88 can be changed as needed.

Elements and/or features of different illustrative embodiments may be combined with each other and/or substituted for each other within the scope of this disclosure and appended claims.

Illustrative embodiments being thus described, it will be apparent that the same may be varied in many ways. Such exemplary variations are not to be regarded as a departure from the scope of the present invention, and all such modifications as would be obvious to one skilled in the art are intended to be included within the scope of the following claims.

The number of constituent elements and their locations, shapes, and so forth are not limited to any of the structure for performing the methodology illustrated in the drawings.

What is claimed is:

1. An image forming apparatus, comprising:
a carriage;
an image forming unit installed in the carriage to eject liquid onto a recording medium to form an image on the recording medium;
a guide member to guide the carriage in a main scanning direction corresponding to a width direction of the recording medium; and
a position restriction member detachably attachable to the carriage to restrict a position of the carriage relative to the guide member in a vertical direction, the carriage comprising:
a first slide member slidably supported by the guide member;
a second slide member that slidably contacts the guide member to prevent rotation of the carriage relative to the guide member; and
a third slide member that slidably contacts the guide member to determine a position of the carriage in a sub-scanning direction perpendicular to the main scanning direction,
wherein the position of the carriage is not restricted by the guide member in the vertical direction.

2. The image forming apparatus according to claim 1, wherein the position restriction member is attached only to the carriage and does not contact the guide member.

3. The image forming apparatus according to claim 1, wherein the position restriction member is a cover that covers an upper surface of the carriage.

4. The image forming apparatus according to claim 1, wherein the position restriction member snaps onto the carriage.

5. The image forming apparatus according to claim 1, further comprising ink tubes disposed within the carriage,
wherein the position restriction member restricts vertical movement of the ink tubes.

6. The image forming apparatus according to claim 1, further comprising a biasing member to bias the carriage against the guide member.

7. The image forming apparatus according to claim 6, wherein:
the biasing member has a slide portion extending along the guide member; and
the biasing member biases the slide portion against the guide member.

8. The image forming apparatus according to claim 1, further comprising:
an encoder scale provided in front of the guide member; and
an encoder scale guide member provided to the carriage, the encoder scale guide member protruding downward from an upper portion of the carriage to guide the encoder scale,
wherein the second slide member extends from the encoder scale guide member toward the guide member to slidably contact the guide member.

9. The image forming apparatus according to claim 1, wherein the guide member comprises:
a first guide member having a substantially cylindrical shape to slidably contact the first and third slide members; and
a second guide member formed separately from the first guide member to slidably contact the second slide member.

10. The image forming apparatus according to claim 1, wherein the guide member comprises:
a vertical portion having a vertical guide surface extending in the vertical direction; and
an upper portion having an upper guide surface provided to an upper part of the guide member and extending horizontally from the vertical guide portion,
wherein the position restriction member comprises a slippage prevention portion hookable into the upper guide surface to prevent slippage of the carriage from the guide member in the vertical direction.

11. The image forming apparatus according to claim 10, wherein the first slide member is provided opposite the upper guide surface.

12. The image forming apparatus according to claim 10, wherein the second slide member contacts the vertical guide surface.

13. The image forming apparatus according to claim 1, wherein the first slide member is provided between the second and third slide members.
